(19) United States
(12) Patent Application Publication
(10) Pub. No.: US 2026/0194093 A1
(43) Pub. Date: Jul. 9, 2026

(54) CLAMP APPARATUS

(71) Applicant: Entry Media, Inc., Winter Park, FL (US)

(72) Inventor: Joseph Holzapfel, Ralston, NE (US)

(21) Appl. No.: 19/441,475

(22) Filed: Jan. 6, 2026

Related U.S. Application Data
(60) Provisional application No. 63/742,168, filed on Jan. 6, 2025.

(51) Int. Cl. F16B 7/04; E06B 11/08

(52) U.S. Cl. CPC F16B 7/0413; E06B 11/08

(57) ABSTRACT

A clamp apparatus is disclosed for securing a sleeve to an arm, such as a turnstile arm, while limiting relative rotation and resisting torsional and impact loads. The clamp apparatus includes an annular flange having first and second apertures and an interior surface extending between the apertures. One or more screws extend through the flange from an exterior surface toward the interior surface and contact respective clamp pads positioned within recesses formed in the interior surface. Tightening the screws drives the clamp pads into engagement with the arm, distributing clamping forces over a contact area larger than the screws alone. In some examples, a pad driver rotatably decouples the screws from the clamp pads to reduce friction and wear. The flange may include threads configured to mate with a sleeve, and opposing clamp apparatuses may be used to resist loosening under alternating torque.

### CROSS-REFERENCE TO RELATED APPLICATIONS

This application claims the benefit of U.S. provisional application no. 63/742,168 filed Jan. 6, 2025, which is hereby incorporated herein in its entirety by reference.

### TECHNICAL FIELD

The present invention relates generally to the field of clamps and clamping devices and, more particularly, to clamp apparatuses configured to secure a sleeve to an arm while limiting relative rotation between the sleeve and the arm.

### BACKGROUND

In some cases, it is desirable to attach two structures, such as a sleeve and an arm, in a manner that permits installation and removal without permanently modifying either structure. One common approach for attaching such structures is the use of a clamp.

Conventional clamp arrangements, however, may permit relative rotation between the structures when a torque is applied to one of the structures. Such torque may arise during normal operation, from external impacts, or from repeated cyclical loading. Relative rotation can result in misalignment, loosening over time, or reduced effectiveness of the attachment.

In addition, some clamp configurations rely on localized point contact or direct engagement between a fastener and a surface of the attached structure. These approaches can concentrate forces in a small area, potentially causing surface damage, deformation, or wear. In applications where the attached structures are subjected to repeated use or environmental exposure, such effects may reduce reliability or service life.

Accordingly, there is a need for an improved clamping approach that can securely attach a sleeve to an arm, resist relative rotation under applied torque, and distribute clamping forces in a manner that reduces localized stress while maintaining a compact and serviceable structure.

### SUMMARY

The present invention relates to a clamp apparatus for securing a sleeve to an arm. In one example, the clamp apparatus includes an annular flange having a first end defining a first aperture and a second end defining a second aperture. The annular flange includes an exterior surface and an interior surface extending from the first aperture to the second aperture. A first screw extends through the annular flange from the exterior surface toward the interior surface and contacts a first clamp pad positioned within a first recess formed in the interior surface. A second screw extends through the annular flange from the exterior surface toward the interior surface and contacts a second clamp pad positioned within a second recess formed in the interior surface. The first screw and the second screw are angularly separated from one another by about 70 degrees to about 120 degrees about a central axis of the annular flange.

In another aspect, the first clamp pad fits within the first recess when the first screw is screwed out and extends beyond the interior surface when the first screw is screwed in. The interior surface and a clamping surface of the first clamp pad may share a radius of curvature, such that the clamping surface is within the first recess when the first screw is screwed out and extends beyond the first recess when the first screw is screwed in. In some examples, the first clamp pad is connected to the first screw and prevents the first screw from being removable through the exterior surface.

In further aspects, the clamp apparatus includes a pad driver having a first end rotatably connected to the first screw and a second end fixedly connected to the first clamp pad, such that the first screw is rotatable independently of the first clamp pad. The first screw may include a cavity, the pad driver may include a radially enlarged portion positioned within the cavity, and a retainer ring may extend around the pad driver to retain the radially enlarged portion within the cavity.

In some aspects, the clamp apparatus further includes screw threads formed on a circumference of the second aperture, and a sleeve may be screwed onto the screw threads. In other examples, the clamp apparatus includes a flange, a screw extending through the exterior surface toward the interior surface, a clamp pad contacted by the screw, and a pad driver rotatably coupling the screw to the clamp pad such that the screw is rotatable independently of the clamp pad. In such examples, the clamp pad may be removable from the pad driver while the screw remains installed in the flange.

In still further aspects, the clamp apparatus includes an annular flange with screw threads formed on a circumference of the second aperture, wherein the clamp pad fits within a recess formed in the interior surface when the screw is screwed out and extends beyond the recess when the screw is screwed in. The clamp apparatus may further include another clamp apparatus screwed onto an opposing end of a sleeve, such that a torque applied in either rotational direction to the sleeve tends to tighten at least one of the clamp apparatuses onto the sleeve.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a perspective view of an example clamp apparatus shown in use, securing a sleeve to an arm in a coaxial arrangement;

FIG. 2 is a front perspective view of an example flange of the clamp apparatus;

FIG. 3 is a rear perspective view of the flange of FIG. 2;

FIG. 4 is a front view of the flange;

FIG. 5 is a rear view of the flange;

FIG. 6 is a front cross-sectional view of the flange, illustrating interior surface geometry, recesses, and threaded features;

FIG. 7 is a top perspective view of a first example of a clamp assembly configured for installation in the flange;

FIG. 8 is a bottom perspective view of the clamp assembly of FIG. 7;

FIG. 9 is a top perspective exploded view of the clamp assembly of FIG. 7, illustrating relative positioning of components;

FIG. 10 is a bottom perspective exploded view of the clamp assembly of FIG. 7;

FIG. 11 is a front cross-sectional view of the assembled clamp assembly of FIG. 7;

FIG. 12 is a front cross-sectional view of a screw of the clamp assembly, illustrating an internal cavity and retention features;

FIG. 13 is a top perspective view of a second example of the clamp assembly, including a removable clamp pad configuration;

FIG. 14 is a bottom perspective view of the clamp assembly of FIG. 13;

FIG. 15 is a front view of the clamp assembly of FIG. 13;

FIG. 16 is a top view of the clamp assembly of FIG. 13;

FIG. 17 is a bottom view of the clamp assembly of FIG. 13;

FIG. 18 is a front perspective view of the clamp apparatus with clamp assemblies installed in the flange;

FIG. 19 is a rear perspective view of the clamp apparatus of FIG. 18;

FIG. 20 is a front cross-sectional view of the clamp apparatus, illustrating relative positioning of the flange and clamp assemblies;

FIG. 21 is a front view of the clamp apparatus with screws in a retracted position;

FIG. 22 is a front view of the clamp apparatus with screws in an engaged, clamping position;

FIG. 23 is a side view of the clamp apparatus attached to a sleeve;

FIG. 24 is a side cross-sectional view of the clamp apparatus attached to the sleeve;

FIG. 25 is a perspective view of the clamp apparatus in use attaching the sleeve to an arm;

FIG. 26 is a side view of two clamp apparatuses attached respectively to opposite ends of the sleeve; and

FIG. 27 is a side cross-sectional view of the configuration shown in FIG. 26.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

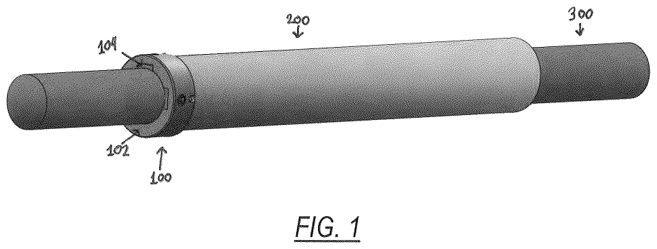

Referring initially to FIG. 1, an example of a clamp apparatus 100 is shown in use attaching a sleeve 200 to an arm 300. In the illustrated example, the arm 300 is a turnstile arm configured to rotate about a central axis of a turnstile assembly, and the sleeve 200 is positioned coaxially over the arm 300. The sleeve 200 may include one or more radially extending structures, such as fins, paddles, plates, spikes, or other protrusions, which increase the effective cross-section of the arm 300 and are intended to deter users from jumping, vaulting, or otherwise bypassing the turnstile. During operation, such radial extensions may be subjected to impact forces, bending moments, and torsional loads that are transmitted to the sleeve 200.

The clamp apparatus 100 provides a mechanical interface between the sleeve 200 and the arm 300 that resists relative rotation, axial movement, and loosening under repeated loading. In particular, the clamp apparatus 100 secures the sleeve 200 to the arm 300 without requiring welding, drilling, or other permanent modification of the arm 300, thereby allowing retrofit installation, replacement, or servicing. As shown in FIG. 1, the clamp apparatus 100 generally includes a flange 102 that is attached to the sleeve 200 and one or more clamp assemblies 104 that engage the arm 300.

In use, the flange 102 is fixed relative to the sleeve 200, while the clamp assemblies 104 generate radially inward clamping forces that press the arm 300 against the interior surface of the flange 102. This arrangement causes torque applied to the sleeve 200—such as torque generated when a user contacts one of the radial extensions—to be reacted through friction and compressive engagement between the clamp apparatus 100 and the arm 300. As a result, relative rotation between the sleeve 200 and the arm 300 is limited or prevented.

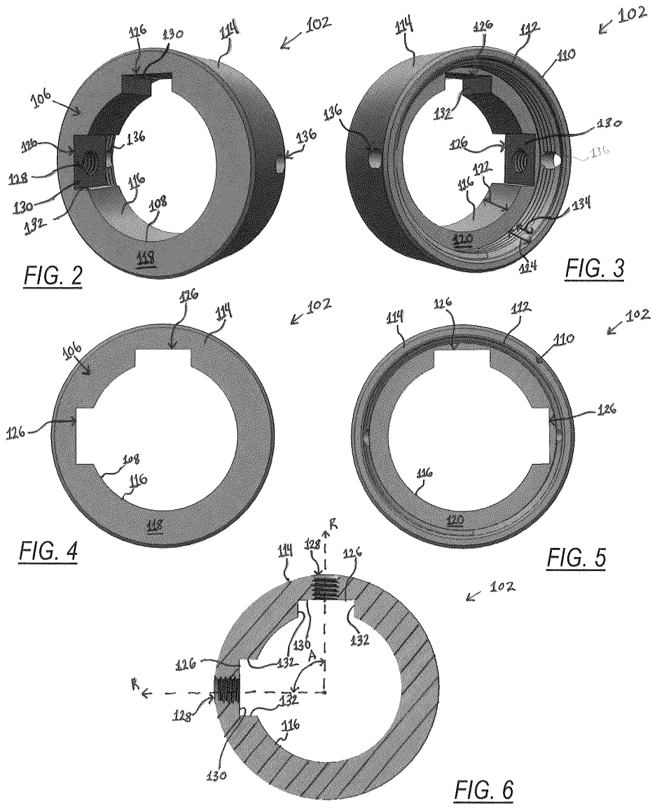

Referring to FIGS. 2-5, the flange 102 is shown in isolation. FIG. 2 is a front perspective view, FIG. 3 is a rear perspective view, FIG. 4 is a front view, and FIG. 5 is a rear view. The flange 102 includes a first end 106 defining a first aperture 108 and a second end 110 defining a second aperture 112. The apertures 108, 112 are generally aligned along a central axis of the flange 102 and are sized to receive the arm 300 and the sleeve 200, respectively.

The flange 102 further includes an exterior surface 114 and an interior surface 116 extending between the first aperture 108 and the second aperture 112. In the illustrated example, the flange 102 has a generally annular configuration. As used herein, “annular” includes closed or partially open ring-like shapes, including circular, C-shaped, polygonal, or other looped geometries capable of surrounding at least a portion of the arm 300.

The exterior surface 114 includes a front face 118, and the interior surface 116 defines a rear face 120. When installed as shown in FIG. 1, the front face 118 generally faces toward the arm 300, while the rear face 120 generally faces toward the sleeve 200. The flange 102 thereby acts as a structural intermediary between the sleeve 200 and the arm 300.

Referring in particular to FIG. 6, which is a front cross-sectional view of the flange 102, the interior surface 116 includes a radially constricted section 122 and a radially elongated section 124. The radially constricted section 122 extends inwardly from the front face 118 toward the rear face 120 and has a smaller effective radius than the radially elongated section 124. The radially elongated section 124 is positioned adjacent the second aperture 112 and provides clearance and attachment structure for the sleeve 200.

The transition between the radially constricted section 122 and the radially elongated section 124 defines a shoulder within the interior surface 116. This shoulder contributes to axial positioning of the sleeve 200 relative to the flange 102 and also provides a reaction surface for loads transmitted between the sleeve 200 and the arm 300.

As shown in FIGS. 2-6, the front face 118 defines a pair of recesses 126 formed in the radially constricted section 122. Each recess 126 extends inwardly from the front face 118 toward the rear face 120. The recesses 126 are spaced circumferentially about the flange 102 and form localized cutouts in the interior surface 116.

The exterior surface 114 further defines a pair of threaded screw holes 128 that extend radially inward toward the interior surface 116 and terminate within the recesses 126. Each screw hole 128 is defined by an outer wall 130, and each recess 126 further includes opposed side walls 132. Together, the outer wall 130 and side walls 132 define a cavity sized to receive components of the clamp assemblies 104, as described in later figures.

In the illustrated example, the recesses 126 extend from the front face 118 to the rear face 120, forming slots that open toward the interior of the flange 102. In other examples, the recesses 126 may extend only partially through the flange 102 or may be formed primarily within the interior surface 116. The number, size, and circumferential spacing of the recesses 126 may vary depending on desired clamping force, arm diameter, or load requirements.

Referring again to FIG. 6, the radially elongated section 124 of the interior surface 116 defines a threaded section 134. The threaded section 134 is configured to mate with corresponding threads formed on the sleeve 200, allowing the flange 102 to be screwed onto the sleeve 200. In the illustrated example, the threaded section 134 extends from the rear face 120 substantially to the second aperture 112, although it may extend over a shorter axial length in other examples.

As shown in FIGS. 2-5, the exterior surface 114 may further define one or more adhesive receiving holes 136 extending from the exterior surface 114 toward the interior surface 116. The adhesive receiving holes 136 terminate at or near the threaded section 134. In use, adhesive may be introduced through the adhesive receiving holes 136 to bond the flange 102 to the sleeve 200, either in addition to or in place of purely threaded retention. This can be advantageous in high-load or high-vibration environments, such as turnstile installations subject to repeated impacts.

Referring specifically to FIG. 6, each screw hole 128 defines an axis R extending through its center. The axes R of the respective screw holes 128 are angularly separated by an angle A. In various examples, angle A may be between approximately 70 degrees and 120 degrees, between approximately 80 degrees and 110 degrees, or approximately 90 degrees. This angular separation is selected to distribute clamping forces around the circumference of the arm 300 while ensuring that forces generated by the clamp assemblies are primarily reacted by the flange 102 rather than directly opposed by another clamp assembly.

By distributing the recesses 126 and screw holes 128 circumferentially in this manner, the flange 102 cooperates with the clamp assemblies 104 to generate stable, distributed contact between the clamp apparatus 100 and the arm 300. This geometry reduces localized stress concentrations, minimizes the risk of denting or deforming the arm 300, and improves resistance to torsional loads applied to the sleeve 200 during use.

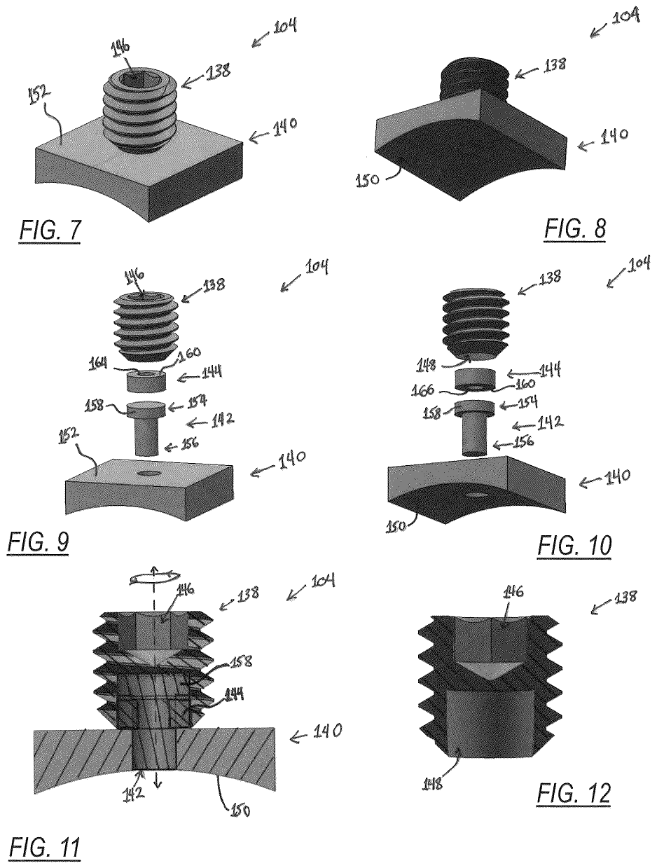

Referring to FIGS. 7-12, a first example of a clamp assembly 104 is shown in greater detail. FIG. 7 is a top perspective view of the clamp assembly 104, FIG. 8 is a bottom perspective view thereof, FIG. 9 is a top perspective exploded view, FIG. 10 is a bottom perspective exploded view, FIG. 11 is a front cross-section view of the assembled clamp assembly 104, and FIG. 12 is a front cross-section view of the screw 138 alone.

As shown collectively in FIGS. 7-10, the clamp assembly 104 includes a screw 138, a clamp pad 140, a pad driver 142, and a retainer ring 144. These components cooperate to transmit clamping force from the screw 138 to the arm 300 while allowing relative rotation between selected components to reduce friction, binding, and wear during tightening and loosening.

Referring to FIGS. 9-12, the screw 138 includes a head 146 at a first end and a cavity 148 formed at a second, opposing end. The head 146 is configured to receive a driving tool, such as a hex driver, although other drive geometries (e.g., Torx, slot, square, or proprietary profiles) may be used. The cavity 148 extends axially into the screw 138 and is sized to receive a portion of the pad driver 142 and the retainer ring 144.

As shown in FIG. 12, the cavity 148 is generally cylindrical and concentric with the longitudinal axis of the screw 138. The cavity 148 may include one or more internal shoulders, grooves, or retention features configured to receive and retain the retainer ring 144 in a fixed axial position relative to the screw 138.

Referring to FIGS. 7-11, the clamp pad 140 includes a clamping surface 150 and a recess surface 152. The recess surface 152 is shaped to mate with and sit within a corresponding recess 126 formed in the flange 102, as described with respect to FIGS. 2-6. In the assembled state, the recess surface 152 faces radially outward toward the interior surface 116 of the flange 102.

The clamping surface 150 faces radially inward and is configured to engage the outer surface of the arm 300. As best shown in FIG. 11, the clamping surface 150 is curved and may share a radius of curvature with the arm 300 and/or with the interior surface 116 of the flange 102. This curvature increases the surface contact area between the clamp pad 140 and the arm 300, distributing clamping forces and reducing localized pressure that could otherwise dent or damage the arm.

In some examples, the clamp pad 140 may be formed as a single piece of material, while in other examples the clamping surface 150 may be formed from a material different from the remainder of the clamp pad 140, such as a softer or higher-friction material to improve grip or reduce wear.

Referring to FIGS. 9-11, the pad driver 142 includes a first end 154 and a second end 156. The first end 154 includes a radially enlarged portion 158, and the second end 156 is fixedly connected to the clamp pad 140.

The radially enlarged portion 158 of the first end 154 is received within the cavity 148 of the screw 138, as shown in FIG. 11. The radially enlarged portion 158 has a diameter greater than the diameter of the apertures in the retainer ring 144, thereby preventing withdrawal of the pad driver 142 from the cavity 148 once the retainer ring 144 is installed.

The second end 156 of the pad driver 142 is fixedly connected to the clamp pad 140 such that the pad driver 142 and clamp pad 140 do not rotate relative to one another. This fixed connection may be achieved by adhesive bonding, welding, soldering, press-fitting, or by forming the pad driver 142 and clamp pad 140 as an integral, single-piece component.

Referring to FIGS. 9-11, the retainer ring 144 is annular and includes an upper face 160 defining an upper aperture 164 and a lower face 162 defining a lower aperture 166. The pad driver 142 extends through both apertures 164, 166 such that the retainer ring 144 surrounds the pad driver 142.

As shown in FIG. 11, the retainer ring 144 is positioned within the cavity 148 of the screw 138 between the radially enlarged portion 158 of the pad driver 142 and the second end 156. The retainer ring 144 is fixed relative to the screw 138, for example by adhesive, welding, soldering, staking, or other retention techniques, such that the retainer ring 144 rotates with the screw 138.

Because the radially enlarged portion 158 of the pad driver 142 is larger than the upper aperture 164 of the retainer ring 144, the retainer ring 144 axially retains the pad driver 142 within the cavity 148. At the same time, the pad driver 142 is free to rotate relative to the retainer ring 144 and the screw 138. This configuration rotatably connects the pad driver 142 to the screw 138.

The rotational decoupling provided by the pad driver 142 allows the screw 138 to be tightened or loosened without causing the clamp pad 140 to rotate against the arm 300. This reduces frictional wear, galling, or surface damage to the arm 300 and improves the ability to achieve consistent clamping force.

As shown in FIGS. 9-11, the clamp assembly 104 is assembled by positioning the radially enlarged portion 158 of the pad driver 142 within the cavity 148 of the screw 138, installing the retainer ring 144 within the cavity 148 to retain the pad driver 142, and fixing the retainer ring 144 in place relative to the screw 138. The clamp pad 140 is fixed to the second end 156 of the pad driver 142 prior to or after installation into the screw 138.

When the clamp assembly 104 is installed in the flange 102 and the screw 138 is rotated, axial movement of the screw 138 causes the clamp pad 140 to move radially inward or outward relative to the flange 102. Tightening the screw 138 causes the clamping surface 150 to press against the arm 300, transferring force from the screw 138 through the pad driver 142 and clamp pad 140 to the arm 300.

The clamp assembly 104 thereby converts rotational input at the screw head 146 into controlled radial clamping force applied over a relatively large surface area of the arm 300. This configuration is particularly advantageous in turnstile applications, where repeated torsional and impact loads may otherwise cause loosening, slippage, or surface damage.

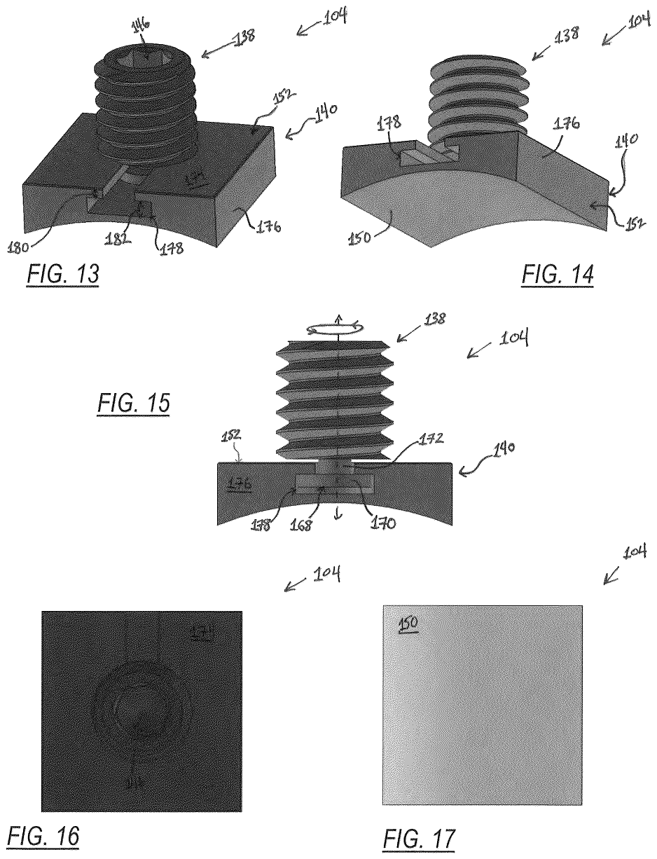

Referring to FIGS. 13-17, a second example of a clamp assembly 104 is shown. FIG. 13 is a top perspective view of the clamp assembly 104, FIG. 14 is a bottom perspective view thereof, FIG. 15 is a front view, FIG. 16 is a top view, and FIG. 17 is a bottom view. This example differs from the clamp assembly described with respect to FIGS. 7-12 primarily in the manner in which the clamp pad 140 is coupled to the screw 138, allowing removal and replacement of the clamp pad 140 without removing or fully loosening the screw 138 from the flange 102.

As shown in FIGS. 13-17, the clamp assembly 104 includes a screw 138 having a head 146 and an extension 168 extending axially from the head 146. The extension 168 includes a radially enlarged section 170 and a radially constricted section 172 positioned between the head 146 and the radially enlarged section 170.

The extension 168 may be integrally formed with the screw 138 or may be formed as a separate component that is fixedly or rotatably connected to the screw 138 by adhesive, welding, soldering, press-fitting, or other attachment techniques. In some examples, the extension 168 rotates together with the screw 138, while in other examples the extension 168 is rotatable relative to the screw 138.

The clamp pad 140 includes a clamping surface 150 configured to engage the arm 300 and a recess surface 152 configured to face radially outward toward the interior surface 116 of the flange 102. The recess surface 152 includes a top face 174 and a plurality of side faces 176 defining the perimeter of the clamp pad 140.

Formed within the recess surface 152 is a dovetail groove 178. The dovetail groove 178 extends inwardly from the top face 174 toward the clamping surface 150 in a first dimension and extends laterally across the recess surface 152 in a second dimension. In the illustrated example, the dovetail groove 178 is generally straight and extends from one side face 176 toward an opposing side face 176, although it does not extend fully to the opposing side face. In other examples, the dovetail groove 178 may extend fully between side faces, may be curved, or may have other orientations.

The dovetail groove 178 includes a retainer section 180 positioned adjacent the top face 174 and a main section 182 positioned between the retainer section 180 and the clamping surface 150. The main section 182 has a larger cross-sectional dimension than the retainer section 180.

The main section 182 is sized to receive the radially enlarged section 170 of the extension 168, while the retainer section 180 is sized to receive the radially constricted section 172. As a result, once the extension 168 is positioned within the dovetail groove 178, the radially enlarged section 170 cannot pass through the retainer section 180 toward the top face 174.

In this configuration, the extension 168 is axially retained within the clamp pad 140 while remaining free to rotate relative to the clamp pad 140. The clamp pad 140 is thus rotatably coupled to the screw 138.

The extension 168 of the screw 138 may be inserted into the dovetail groove 178 by sliding the radially enlarged section 170 into the main section 182 through one of the side faces 176. Once inserted, the extension 168 is captured by the retainer section 180 and cannot be withdrawn through the top face 174.

The clamp pad 140 may be removed from the screw 138 by sliding the extension 168 laterally out of the dovetail groove 178 through the side face 176. This removal can be performed while the screw 138 remains installed in the flange 102, thereby simplifying maintenance and replacement.

This removable clamp pad configuration allows a clamp pad 140 to be replaced without disturbing the position or torque of the screw 138. This is particularly advantageous in installations where access to the screw head 146 is limited or where repeated removal of screws could cause thread wear in the flange 102.

Additionally, the removable clamp pad configuration allows clamp pads 140 made from different materials to be interchanged. For example, a clamp pad 140 formed from a first material may be replaced with a clamp pad 140 formed from a second material to reduce friction, prevent galvanic corrosion, mitigate cold welding, or accommodate different arm surface finishes.

In applications where the clamp apparatus 100 is exposed to environmental factors such as moisture, temperature cycling, or contaminants, the ability to replace worn or degraded clamp pads 140 without removing the screw 138 improves serviceability and extends the operational life of the clamp apparatus 100.

The clamp assembly 104 of FIGS. 13-17 therefore provides a modular, serviceable alternative to the clamp assembly of FIGS. 7-12, while maintaining the ability to apply distributed radial clamping force to the arm 300 and resist torsional and impact loads applied to the sleeve 200.

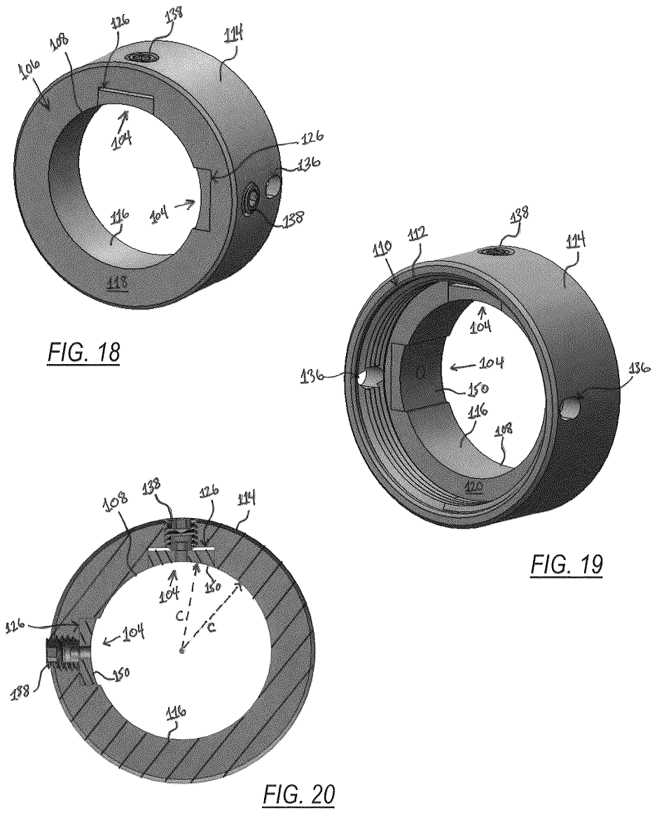

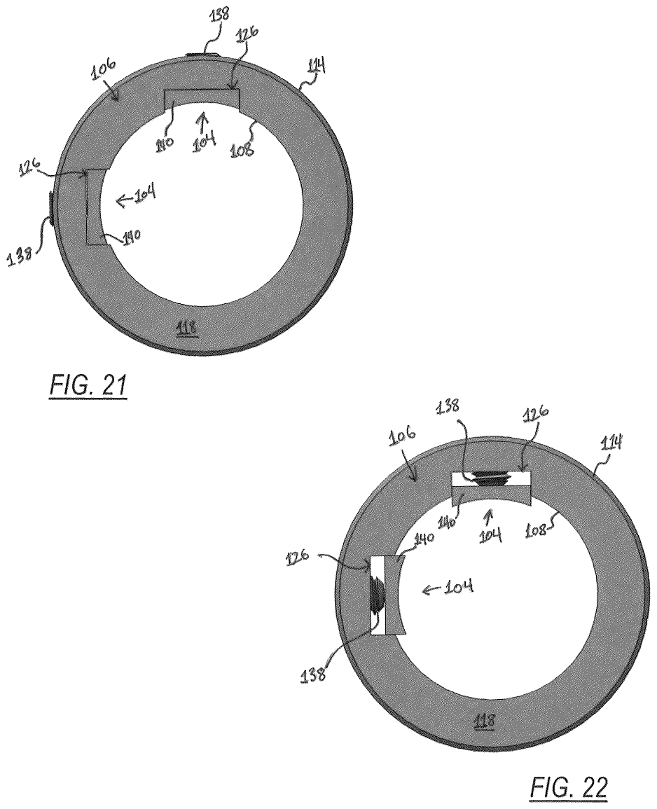

Referring to FIGS. 18-22, the clamp apparatus 100 is shown in an assembled configuration and in various stages of adjustment. FIG. 18 is a front perspective view of the clamp apparatus 100, FIG. 19 is a rear perspective view thereof, FIG. 20 is a front cross-sectional view thereof, FIG. 21 is a front view with the screws 138 screwed out, and FIG. 22 is a front view with the screws 138 screwed in.

As shown in FIGS. 18 and 19, the clamp apparatus 100 includes the flange 102 with a plurality of clamp assemblies 104 installed therein. In the illustrated example, two clamp assemblies 104 are installed in respective recesses 126 formed in the flange 102, although more or fewer clamp assemblies may be used depending on the desired clamping force, arm diameter, or load requirements.

Each clamp assembly 104 is installed by threading its screw 138 through a corresponding threaded screw hole 128 in the flange 102. The screw 138 extends radially through the flange 102 from the exterior surface 114 toward the interior surface 116. The clamp pad 140 is positioned within the recess 126 such that the recess surface 152 of the clamp pad 140 faces radially outward toward the interior surface 116 of the flange 102.

Referring to FIG. 20, which is a front cross-sectional view of the assembled clamp apparatus 100, the relative positioning of the clamp assemblies 104, flange 102, and interior passage is shown. The clamp pads 140 are positioned radially inward of the flange 102 and are capable of moving between a retracted position and an extended, clamping position as the screws 138 are rotated.

As shown in FIG. 20, the clamping surface 150 of each clamp pad 140 shares a radius of curvature C with the interior surface 116 of the flange 102 and/or with the outer surface of the arm 300. This shared curvature increases the area of contact when the clamp pad 140 engages the arm 300 and promotes uniform force distribution.

Referring to FIG. 21, the clamp apparatus 100 is shown with the screws 138 screwed out, corresponding to a retracted or open configuration. In this configuration, the clamp pads 140 are positioned substantially within the recesses 126, and the clamping surfaces 150 do not extend inwardly beyond the interior surface 116 of the flange 102. This configuration provides sufficient clearance to position the clamp apparatus 100 over the arm 300 during installation or removal.

Referring to FIG. 22, the clamp apparatus 100 is shown with the screws 138 screwed in, corresponding to an engaged or clamping configuration. As the screws 138 are tightened, axial movement of the screws 138 causes the clamp pads 140 to move radially inward relative to the flange 102. In this configuration, the clamping surfaces 150 extend inwardly beyond the interior surface 116 and are configured to contact and press against the outer surface of the arm 300.

In the engaged configuration shown in FIG. 22, the recess surfaces 152 of the clamp pads 140 are substantially flush with the interior surface 116 of the flange 102. This flush interface stabilizes the clamp pads 140 against tilting or cocking within the recesses 126 and ensures that clamping forces are transmitted efficiently from the screws 138 to the arm 300.

When the screws 138 are tightened, the clamp pads 140 transfer clamping force from the screws 138 to the arm 300 through the clamping surfaces 150. Because the clamping surfaces 150 have a greater surface area than the cross-sectional area of the screw tips, the applied force is distributed over a larger area of the arm 300, reducing localized pressure and minimizing the risk of surface damage, deformation, or denting of the arm 300.

The circumferential spacing of the clamp assemblies 104 causes the forces applied by the clamp pads 140 to be distributed around the arm 300. Due to the selected angular separation between clamp assemblies, the primary reaction forces are provided by the flange 102 rather than by direct opposition between clamp pads. This configuration improves stability and increases resistance to torsional loads applied to the clamp apparatus 100.

As shown in FIGS. 21 and 22, the clamp pads 140 prevent removal of the screws 138 through the exterior surface 114 of the flange 102. Because the clamp pads 140 are larger than the screw holes 128, the screws 138 remain captured within the flange 102 even when loosened. This feature reduces the risk of losing screws during installation, removal, or maintenance.

The assembled clamp apparatus 100 shown in FIGS. 18-22 therefore provides a compact, robust, and serviceable structure capable of securely attaching a sleeve 200 to an arm 300 while resisting torsional, shear, and impact loads, such as those encountered in turnstile applications with anti-vault sleeves.

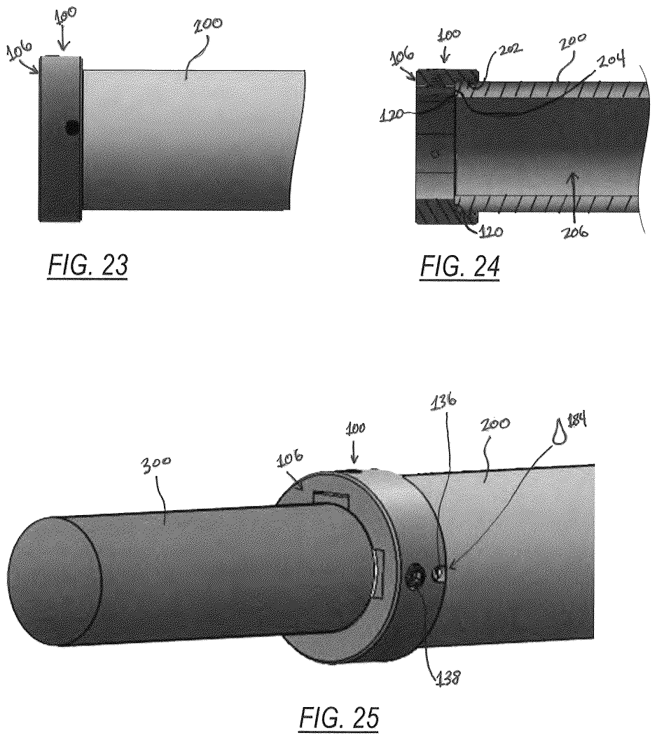

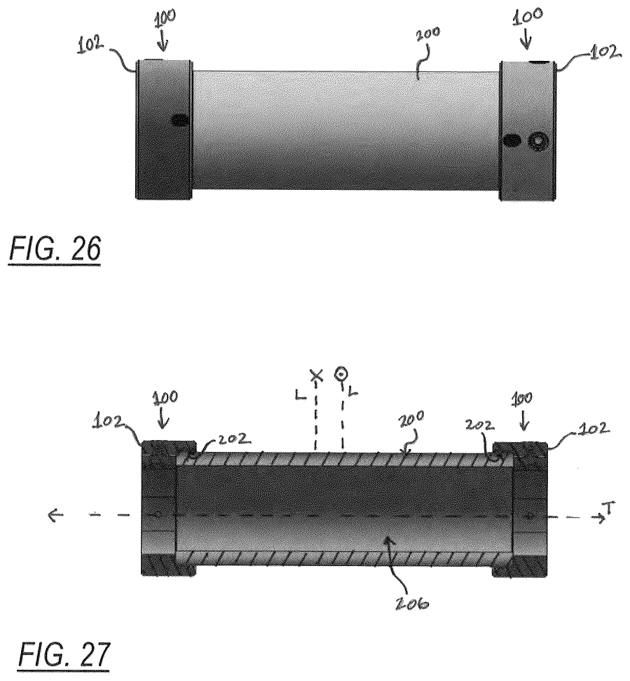

Referring to FIGS. 23-27, the clamp apparatus 100 is shown attached to the sleeve 200 and in use securing the sleeve 200 to the arm 300. FIG. 23 is a side view of the clamp apparatus 100 attached to the sleeve 200, FIG. 24 is a side cross-section view thereof, FIG. 25 is a perspective view of the clamp apparatus 100 in use attaching the sleeve 200 to the arm 300, FIG. 26 is a side view of two clamp apparatuses 100 attached respectively to opposite ends 204 of the sleeve 200, and FIG. 27 is a side cross-section view thereof.

Referring to FIGS. 23 and 24, the flange 102 of the clamp apparatus 100 is attached to the sleeve 200 by mating the threaded section 134 formed on the interior surface 116 of the flange 102 with corresponding threads 202 formed on an exterior surface of the sleeve 200. In the illustrated example, the sleeve 200 includes a generally cylindrical end 204 configured to receive the flange 102 in a coaxial arrangement.

As shown in FIG. 24, when the flange 102 is fully installed, the end 204 of the sleeve 200 is positioned substantially flush with the rear face 120 of the flange 102. This axial relationship assists in positioning the sleeve 200 relative to the clamp apparatus 100 and provides a defined load path for forces transmitted between the sleeve 200 and the flange 102.

In some examples, adhesive 184 may be applied to the threaded interface between the threaded section 134 and the threads 202 of the sleeve 200. The adhesive 184 may be introduced through the adhesive receiving holes 136 formed in the exterior surface 114 of the flange 102, either before or after the flange 102 is threaded onto the sleeve 200. The adhesive 184 may function to increase resistance to loosening, vibration, or cyclic torsional loading.

The sleeve 200 may be hollow, defining a hollow interior 206, as shown in FIG. 24, or may be solid in other examples. The sleeve 200 may be formed from metal, polymer, composite, or other suitable materials, and may include one or more radially extending anti-vault structures, as described previously.

Referring to FIG. 25, the clamp apparatus 100 is shown in use attaching the sleeve 200 to the arm 300. In this configuration, the arm 300 extends through the first aperture 108 of the flange 102 and may extend partially into the hollow interior 206 of the sleeve 200. The arm 300 and the sleeve 200 are coaxially aligned.

With the clamp apparatus 100 positioned around the arm 300, the screws 138 of the clamp assemblies 104 are tightened to drive the clamp pads 140 radially inward into engagement with the outer surface of the arm 300. As the clamp pads 140 engage the arm 300, forces are transferred from the screws 138 through the clamp pads 140 to the arm 300, pressing the arm 300 against the interior surface 116 of the flange 102.

The interior surface 116 of the flange 102 exerts equal and opposite reaction forces on the arm 300. The arm 300 is thereby captured between the clamp pads 140 and the interior surface 116 of the flange 102, creating a stable clamping condition that resists axial movement and relative rotation.

In applications where the sleeve 200 includes radially extending anti-vault structures, such as turnstile installations, torsional and bending loads may be applied to the sleeve 200 during use. These loads are transmitted from the sleeve 200 to the flange 102 through the threaded interface and, in turn, from the flange 102 to the arm 300 through the clamp assemblies 104.

Because the clamp pads 140 are circumferentially spaced around the arm 300, the resulting frictional engagement between the clamp pads 140 and the arm 300 is distributed over multiple contact regions. This distributed engagement increases resistance to relative rotation between the sleeve 200 and the arm 300 as compared to point-contact fasteners or set-screw arrangements.

Additionally, bending moments applied to the sleeve 200 are resisted by the flange 102, which reacts loads through the interior surface 116 on the side of the arm 300 opposite the clamp pads 140. This multi-point constraint reduces localized stress and improves overall stability of the attachment.

Referring to FIGS. 26 and 27, two clamp apparatuses 100 are shown attached respectively to opposite ends 204 of the sleeve 200. FIG. 26 illustrates the arrangement in side view, and FIG. 27 illustrates the arrangement in side cross-section.

In the illustrated example, the threaded section 134 of each flange 102 and the corresponding threads 202 on the sleeve 200 are all right-handed. In other examples, the threads may be left-handed or otherwise oriented.

When a torque L is applied to the sleeve 200 about an axis T extending through the sleeve 200, the applied torque tends to tighten one of the flanges 102 onto the sleeve 200 while potentially loosening the other flange 102, depending on the direction of the applied torque. Over time, as alternating torques L are applied in both rotational directions during normal use, at least one of the flanges 102 will tend to remain tightly threaded onto the sleeve 200.

This dual-clamp configuration therefore provides a self-reinforcing attachment that resists loosening under alternating torsional loads. In combination with the clamping engagement of each clamp apparatus 100 to the arm 300, the dual-clamp configuration improves long-term stability and reliability in high-use environments such as turnstiles.

The configuration shown in FIGS. 26 and 27 further limits relative rotation between the sleeve 200 and the arm 300 by increasing the effective axial length over which clamping forces are applied. This extended engagement length reduces stress concentrations and improves resistance to both torsional and bending loads.

Accordingly, the clamp apparatus 100 and the configurations illustrated in FIGS. 23-27 provide a secure, serviceable, and non-permanent solution for attaching an anti-vault sleeve to a turnstile arm while accommodating repeated use, impact, and cyclic loading.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A clamp apparatus comprising:
an annular flange having a first end defining a first aperture and a second end defining a second aperture;
an exterior surface of the annular flange, and an interior surface of the flange that extends from the first aperture to the second aperture;
a first screw extending through the annular flange from the exterior surface toward the interior surface and contacting a first clamp pad positioned within a first recess formed in the interior surface; and
a second screw extending through the annular flange from the exterior surface toward the interior surface and contacting a second clamp pad positioned within a second recess formed in the interior surface, wherein the first screw and the second screw being angularly separated from one another by 70 degrees to 120 degrees about a central axis of the annular flange.

2. The clamp apparatus of claim 1, wherein the first clamp pad fits within the first recess when the first screw is screwed out and extends beyond the interior surface when the first screw is screwed in.

3. The clamp apparatus of claim 1, wherein the interior surface and a clamping surface of the first clamp pad share a radius of curvature, the clamping surface is within the first recess when the first screw is screwed out, and the clamping surface extends beyond the first recess when the first screw is screwed in.

4. The clamp apparatus of claim 1, wherein the first clamp pad is connected to the first screw and prevents the first screw from being removable through the exterior surface.

5. The clamp apparatus of claim 1, further comprising a pad driver having a first end rotatably connected to the first screw and a second end fixedly connected to the first clamp pad, wherein the first screw is rotatable independently of the first clamp pad.

6. The clamp apparatus of claim 5, wherein the first screw includes a cavity, the pad driver includes a radially enlarged portion positioned within the cavity, and a retainer ring extends around the pad driver and retains the radially enlarged portion within the cavity.

7. The clamp apparatus of claim 1, further comprising screw threads formed on a circumference of the second aperture.

8. A clamp apparatus comprising:
a flange having a flange first end defining a first aperture and a flange second end defining a second aperture;
an exterior surface of the flange, and an interior surface of the flange that extends from the first aperture to the second aperture;
a screw extending through the exterior surface toward the interior surface;
a clamp pad contacted by the screw; and
a pad driver having a first end rotatably connected to the screw and a second end fixedly connected to the clamp pad, wherein the screw is rotatable about the pad driver independently of the clamp pad.

9. The clamp apparatus of claim 8, wherein the clamp pad fits within a recess formed in the interior surface when the screw is screwed out and extends beyond the interior surface when the screw is screwed in.

10. The clamp apparatus of claim 8, wherein the clamp pad is connected to the screw and prevents the screw from being removable through the exterior surface.

11. The clamp apparatus of claim 8, wherein the screw includes a cavity, the pad driver includes a radially enlarged portion positioned within the cavity, and a retainer ring extends around the pad driver and retains the radially enlarged portion within the cavity.

12. The clamp apparatus of claim 8, wherein the clamp pad is removable from the pad driver while the screw remains installed in the flange.

13. The clamp apparatus of claim 8, further comprising screw threads formed on a circumference of the second aperture.

14. The clamp apparatus of claim 13, further comprising a sleeve screwed onto the screw threads.

15. A clamp apparatus comprising:
an annular flange having a first end defining a first aperture and a second end defining a second aperture;
an exterior surface of the annular flange, an interior surface of the annular flange extending from the first aperture to the second aperture;
a screw extending through the exterior surface toward the interior surface and contacting a clamp pad; and
screw threads formed on a circumference of the second aperture, wherein the clamp pad fits within a recess formed in the interior surface when the screw is screwed out and extends beyond the recess when the screw is screwed in.

16. The clamp apparatus of claim 15, wherein the clamp pad is connected to the screw and prevents the screw from being removable through the exterior surface.

17. The clamp apparatus of claim 15, wherein the interior surface and a clamping surface of the clamp pad share a radius of curvature, the clamping surface is within the recess when the screw is screwed out, and the clamping surface extends beyond the recess when the screw is screwed in.

18. The clamp apparatus of claim 15, further comprising a pad driver rotatably coupling the screw to the clamp pad such that the screw is rotatable independently of the clamp pad.

19. The clamp apparatus of claim 15, further comprising a sleeve screwed onto the screw threads.

20. The clamp apparatus of claim 15, further comprising another clamp apparatus, wherein both clamp apparatuses are respectively screwed onto opposing ends of the sleeve and a torque applied in either rotational direction to the sleeve tends to tighten at least one of the clamp apparatuses onto the sleeve.
